(19) United States
(12) Patent Application Publication
(10) Pub. No.: US 2015/0354661 A1
(43) Pub. Date: Dec. 10, 2015

(54) Cylinder Unit Having An Adhesive Bond

(71) Applicant: ZF FRIEDRICHSHAFEN AG, Friedrichshafen (DE)

(72) Inventors: Robert PRADEL, Roethlein (DE); Josef RENN, Dettelbach (DE); Andreas SIEBER, Schweinfurt (DE); Klaus SCHREINER, Windeck (DE); Wolfgang HERTZ, Sankt Augustin (DE); Dirk BECKER, Willroth (DE); Markus SCHÄFER, Winterhausen (DE)

(21) Appl. No.: 14/762,330

(22) PCT Filed: Jan. 9, 2014
(86) PCT No.: PCT/EP2014/050283

§ 371 Date: Jul. 21, 2015

(30) Foreign Application Priority Data
Jan. 28, 2013 (DE) 10 2013 201 301.9

(51) Int. Cl. F16F 9/54; F16F 9/32; B60G 13/00

(52) U.S. Cl. CPC F16F 9/54; B60G 13/006; F16F 9/3242; B60G 2204/4304; B60G 2206/821; F16F 2226/042

(57) ABSTRACT

A cylinder unit includes a cylinder which is closed at one end by a base, wherein an adhesive joint is formed between the cylinder and the base, characterized in that the adhesive joining of the base is carried out in an annular space filled with adhesive, wherein the cylinder or the base is wetted with adhesive in the annular space at an inner wall and at an outer wall so that there are two gluing surfaces separated by the wall.

### PRIORITY CLAIM

This is a U.S. national stage of application No. PCT/EP2014/050283, filed on Jan. 9, 2014. Priority is claimed on the following application: Country: Germany, Application No.: 10 2013 201 301.9, Filed: Jan. 28, 2013, the content of which is/are incorporated herein by reference in its entirety.

### FIELD OF THE INVENTION

The invention is directed to a cylinder unit with an adhesive joint between the cylinder and a base.

### BACKGROUND OF THE INVENTION

In a cylinder unit in the constructional form of a vibration damper, mounting parts, e.g., stabilizer holders, spring disks or wheel supports, are generally welded on. Positive engagement joints are also occasionally used. The same is true of the joint between a cylinder and a base of the vibration damper. Weld joints and positive engagement connections basically have the disadvantage that corrosion necessitates considerable precautions.

It has been considered for some time to replace existing weld joints or positive engagement connections with adhesive joints. For example, DE 10 2004 003 423 A1 discloses a vibration damper having a wheel support that is secured to the outer cylinder by an adhesive layer.

DE 102 08 560 B4 discloses that the base and the cylinder are held together by an adhesive joint. A connection member is formed at the base.

However, adhesive techniques could not gain acceptance heretofore particularly in vibration dampers because the required loads could not be handled reliably.

It is an object of the present invention to provide a reliable adhesive joint at a cylinder unit.

### SUMMARY OF THE INVENTION

This object is met according to the invention in that the adhesive joining of the base is carried out in an annular space filled with adhesive, wherein the cylinder or the base is wetted with adhesive in the annular space at an inner wall and at an outer wall so that there are two gluing surfaces separated by the wall.

The advantage of this constructional principle consists in that one component, e.g., the cylinder, has two gluing surfaces at one end because the other component contacts both the inner wall and outer wall. With load on the base or cylinder, the gluing surfaces of the base are supported especially well relative to the cylinder through the two-shelled configuration. A deformation of the cylinder is additionally counteracted either by the inner shell of the base or by the outer shell of the base.

In an embodiment, it is provided that the base is constructed in a two-shelled manner, the two shells of the base radially limiting the annular space which receives one end of the cylinder. The two-shelled configuration of the base facilitates the production of the base, particularly when the base is provided as a shaped part.

To avoid a weld joint between the two shell parts, both shells of the base can be glued to one another along the bottom regions thereof.

One embodiment can consist in that a mounting part on the cylinder side overlaps a gluing surface between the base and the cylinder, the mounting part radially limits the annular space, and the mounting part is connected to the cylinder and also to the base. In this case, the cylinder is covered by the base on the one hand and by the mounting part on the other hand. The base can have a simple constructional shape because it need only form a boundary of the annular space.

In a further advantageous configuration, the mounting part and a shell of the base are constructed integrally. This embodiment is particularly stable because a gluing surface between the base and mounting part is omitted.

In one embodiment form, the cross section of the cylinder has a length portion with a radius reduction, this radius reduction corresponding at least to the wall thickness of the base. In this case, the base rather than the cylinder is inserted in the annular space in the adhesive.

It can be provided that the outer gluing surface between the cylinder and the base is axially shorter than the length portion with the radius reduction such that there is a gap for adhesive between the mounting part and the cylinder. This constructional shape provides for a defined gap cross section between the mounting part and the cylinder.

### BRIEF DESCRIPTION OF THE DRAWINGS

The invention will be explained more fully with reference to the following description of the drawings, in which:

FIGS. 1 and 2 show a cylinder-base connection with a two-shelled base;

FIGS. 3 and 4 show a two-shelled base with a mounting part at the cylinder;

FIG. 5 shows a single-shell base with annular space for a mounting part;

FIG. 6 shows a single-shell base in an annular space between a mounting part and the cylinder; and

FIG. 7 shows another embodiment according to FIG. 6 with a two-shelled base.

### DETAILED DESCRIPTION OF THE PRESENTLY PREFERRED EMBODIMENTS

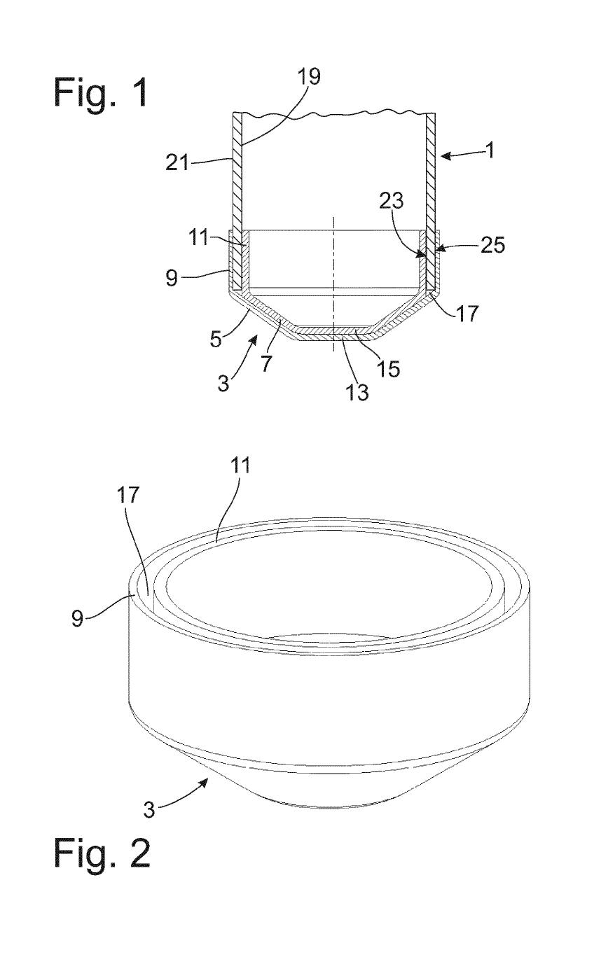

Viewed in conjunction, FIG. 1 and FIG. 2 show one end of a cylinder 1, e.g., of a vibration damper. The cylinder 1 is closed at the end in a pressure-tight manner by a base 3. The base 3 is constructed in a two-shelled manner. Each individual shell 5; 7 has a tubular portion 9; 11 and a bottom region 13; 15. The tubular portions 9; 11 extend parallel to one another and radially limit an annular space 17 which is filled with an adhesive and receives the end of the cylinder 1. In this embodiment form, the two tubular portions 9; 11 have the same length, although different lengths could certainly also be provided. The two individual shells 5; 7 are connected to one another, e.g., by means of an adhesive joint, along a bottom region 13; 15. Alternatively, a primary-shaped base can also be provided, e.g., as sintered or plastic component part. An adhesive joining of the base to the cylinder is achieved through the annular space 17 filled with adhesive, wherein the cylinder 1 is wetted by the adhesive in the annular space 17 at an inner wall 19 and at an outer wall 21 so that there are two gluing surfaces 23; 25 separated by the wall of the cylinder.

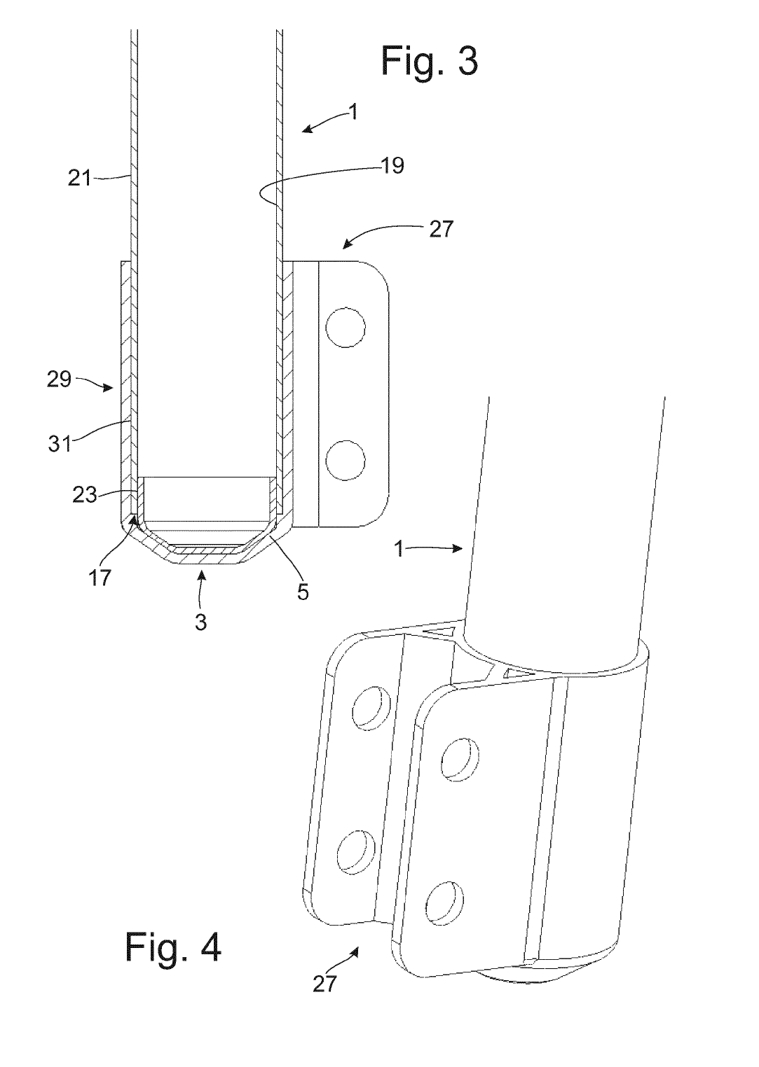

FIGS. 3 and 4 show a variant in which a mounting part 27 is fixed to the cylinder 1. The mounting part 27 is constructed, for example, as a wheel support of a vibration damper.

The mounting part 27 on the cylinder side has a tubular portion 29 which overlaps the gluing surface 23 between the base 3 and the cylinder 1, wherein the mounting part 27 radially limits the annular space 17. The mounting part 27 is connected to the cylinder 1 and to the base 3.

The mounting part 27 and the outer shell part 5 of the base 3 are formed integrally in FIG. 3. An adhesive joint at a gluing surface 31 between the mounting part 27 and the outer wall 21 of the cylinder 1 can be formed appreciably longer axially than gluing surface 23 in the region of the inner wall 19.

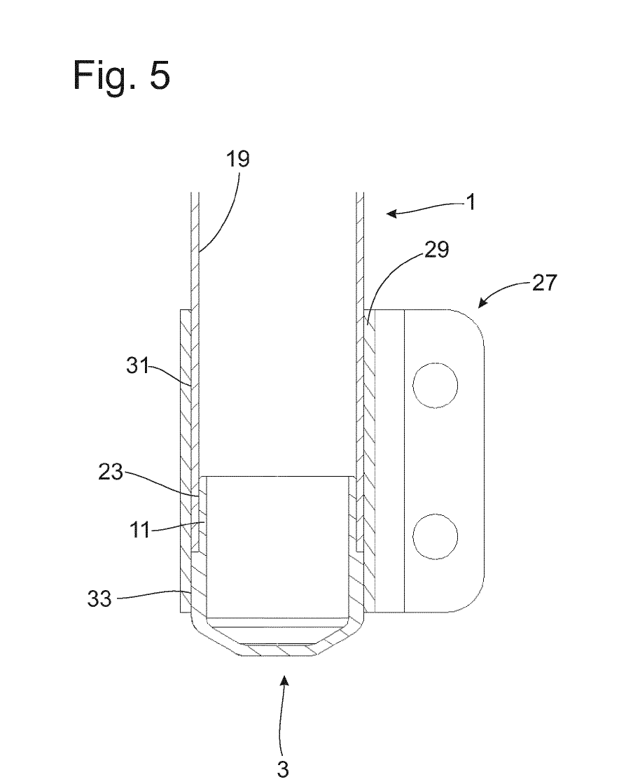

The variant according to FIG. 5 is configured similar to FIG. 3. The tubular portion 11 of base 3 and the mounting part 27 form the aforementioned annular space 17 for receiving the end of the cylinder. In contrast, the base 3 is formed with one shell. The gluing surface 23 is provided between tubular portion 11 of base 3 and inner wall 19 and an end face of cylinder 1. Further, in the region of gluing surface 23 of the cylinder with the tubular portion of the base 11, there is a gluing surface 31 between mounting part 27 and cylinder 1 adjoining a further gluing surface 33 between the tubular portion 11 of base 3 and the tubular portion 29 of mounting part 27.

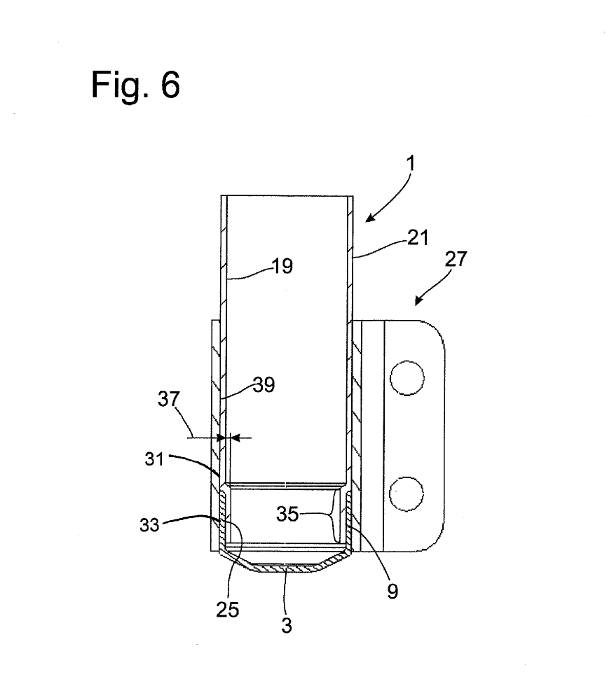

FIG. 6 shows by way of example a mounting part 27 according to FIG. 5 at a cylinder 1 whose cross section has a radius reduction 37 on a length portion 35. The radius reduction 37 corresponds at least to the wall thickness of the base 3. In this variant, the tubular portion of the single-shell base 3 is inserted in the adhesive in the annular space 17 between outer wall 21 of cylinder 1 and inner wall 39 of mounting part 27. In this case, also, gluing surfaces 31, 33 between mounting part 27 and cylinder 1 and between mounting part 27 and base 3 directly adjoin one another.

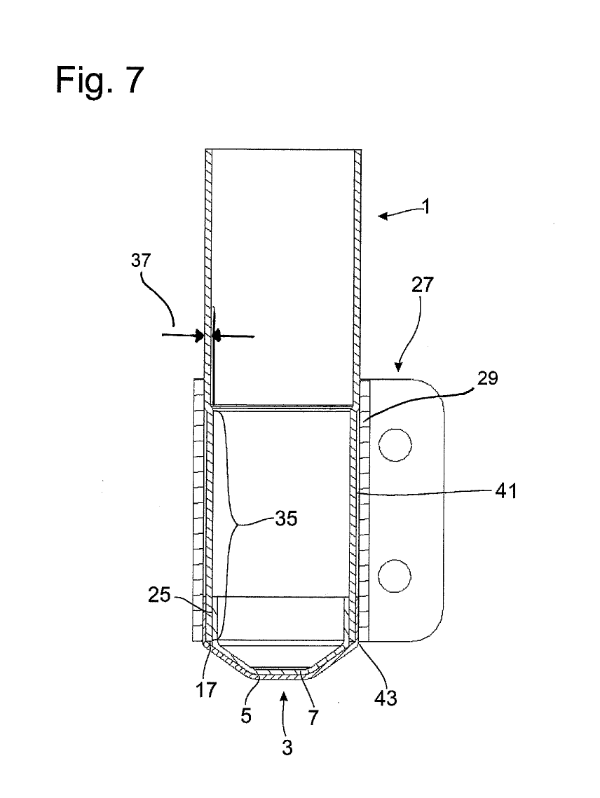

FIG. 7 discloses a variant comprising a combination of base 3 from FIG. 1 and with a cylinder 1 and a mounting part 27 according to FIG. 6. In contrast, the outer gluing surface 25 between cylinder 1 and base 3 is axially shorter than the length portion 35 with the radius reduction 37 so that there is a gap 41 for adhesive between mounting part 27 and cylinder 1. Accordingly, there is an overlapping region in which the inner shell part 7 of base 3, the cylinder 1, the outer shell part 5 and the tubular portion 29 of mounting part 27 are layered, and three gluing layers are accordingly available. Accordingly, there are two annular spaces 17, 43 available, each of which receives a structural component part, namely, cylinder 1 and outer shell part 5, in the adhesive.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A cylinder unit comprising:
a cylinder (1) having an end;
a base (3) for closing said cylinder (1) at said end;
an adhesive joint formed between said cylinder (1) and said base (3);
said adhesive joint comprising an annular space (17) including an adhesive for joining of said base (3) to said cylinder (1), each of said cylinder (1) and said base (3) having a wall comprising an inner wall and an outer wall; and
wherein one of said cylinder (1) and said base (3) is wetted with said adhesive in said annular space (17) at said respective inner wall and said respective outer wall so that there are two gluing surfaces separated by said wall of one of said cylinder (1) and said base (3).

9. The cylinder unit according to claim 8, wherein said base (3) comprises two-shell parts, and wherein the two shell parts (5; 7) of the base (3) radially limit the annular space (17).

10. The cylinder unit according to claim 9, wherein the two shell parts (5; 7) of the base comprise a bottom region (13; 15) and wherein the two shell parts (5; 7) are glued to one another along said bottom regions (13; 15).

11. The cylinder unit according to claim 8, additionally comprising a mounting part (27) on the cylinder side overlapping a gluing surface (23) between the base (3) and the cylinder (1), and wherein the mounting part (27) radially limits the annular space (17) and is connected to the cylinder (1) and to the base (3).

12. The cylinder unit according to claim 11, wherein the mounting part (27) and the base (3) are constructed integrally.

13. The cylinder unit according to claim 8, wherein the base (3) has a wall thickness and the cylinder has a cross-section and a length portion (35) with a radius reduction (37), and wherein the radius reduction (37) corresponds at least to the wall thickness of the base (3).

14. The cylinder unit according to claim 13, wherein the two gluing surfaces comprise an outer gluing surface (25) between the cylinder (1) and the base (3), and wherein the outer gluing surface (25) is axially shorter than the length portion (35) with the radius reduction (37) so as to form a gap (41) for the adhesive between the mounting part (27) and the cylinder (1).
